(19) United States
(12) Patent Application Publication
(10) Pub. No.: US 2010/0024499 A1
(43) Pub. Date: Feb. 4, 2010

(54) High Security Cylinder Lock

(76) Inventors: Forrest Xu, West Covina, CA (US); Daniel Xu, West Covina, CA (US)

Correspondence Address: FORREST XU, P.O.Box 2641, WEST COVINA, CA, 91791, US

(21) Appl. No.: 12/533,819

(22) Filed: Jul. 31, 2009

Related U.S. Application Data
(60) Provisional application No. 61/085,845, filed on Aug. 2, 2008.
(60) Provisional application No. 61/094,987, filed on Sep. 8, 2008.

(51) Int. Cl. E05B 63/00; E05B 27/08

(52) U.S. Cl. 70/494; 70/419

(57) ABSTRACT

A high security cylinder lock includes a housing comprising a plurality of driver pin bores for disposing spring loaded driver pins; a plug rotatable within the housing comprising a plurality of balancing pin bores for disposing spring loaded balancing pins and a plurality of combination pin bores for disposing combination pins. Each combination pin is sandwiched between a driver pin and a balancing pin. The extension force of the balancing spring at its pre-load length is greater than the extension force of the driver spring at its fully-load length. The compound force causes at least one combination pin partially extended into a corresponding driver pin bore in the housing when the plug is at its first rotational orientation in case of no key engaged. The key profile pushes the balancing pins to move to such position that all mating surfaces of the combination pins and the driver pins to lies onto the shear line of the lock. The balancing pin, balancing spring and balancing spring seal set may be substituted by magnetic balancing pin and magnetic seal pin set.

### FIELD OF THE INVENTION

The present invention relates to a cylinder lock. More specifically, the present invention relates to cylinder lock of pin tumbler type with pick-resistant mechanism to prevent it from being opened by conventional lock picking or bumping methods.

### BACKGROUND OF THE INVENTION

The following U.S. patents are believed to represent the prior state of the art:
U.S. Pat. Nos. 593,436; 1,095,500; 3,484,159; 3,731,507; and 5,964,111.

As evidenced by these patents, a typical cylinder lock in the prior state of the art generally includes a housing compressing a plurality of driver pin bores; a plug, rotatable within the shell, compressing a plurality of combination pin bores facing to their corresponding driver pin bores on the housing; a plurality of spring loaded driver pins seated in the driver pin bores on the housing, a plurality of combination pins resided in the combination pin bores on the plug. The locking mechanism is created by having driver pins extended into the combination pin bores on the plug so to block the plug from rotating. The other end of the combination pins expose to an opening keyway for receiving and transferring external force from a pre-determined key profile. When the key with correct profile engages, it forces all combination pins to such position that all mating end of the combination pin and driver pin lies onto the shear line, and the plug is then unlocked. Since all combination pins normally expose directly to the keyway, they are relatively easier to be accessed and manipulated by picking or bumping tools. To pick a conventional cylinder lock, one needs to apply a small rotation torque to the plug first and to employ a picking tool to tentatively depress a selective combination pin exposed to the keyway so to find a skewed pin. The skewed pin is normally not the combination pin exposed to the keyway but the driver pin that extended into the combination pin bore on the plug. One further depresses the combination pin until the driver pin goes across the shear line. Repeatedly using this method on one pin by another will have all pins lie on to the share line and have the lock unlocked.

So far as we know, most development based on the prior state of the art that tried to provide relatively higher level of security has not changed the core nature of dual-pin-single-spring configuration. So its basic disadvantage of easily being picked open has not changed theoretically.

### SUMMARY OF THE INVENTION

It is the primary object of the present invention to provide a cylinder pin tumbler lock with a new locking mechanism that is highly resistant to lock picking and bumping attempt.

It is another related object of the present invention to provide a cylinder pin tumbler lock that is generally cost efficient to manufacture.

It is a further related object of the present invention to provide a cylinder pin tumbler lock that is easy to be assembled, mastered and serviced.

The foregoing mentioned objects and other objects of the present invention are achieved by providing an exemplary cylinder lock that comprises a housing having a through bore and a plurality of driver pin bores communicating with the through bore and outer peripheral surface; a plurality of driver pins and driver springs being slidably disposed into the driver pin bores then sealed by driver pin bore seals; a plug rotatable in the through bore in the housing having a keyway, a plurality of balancing pin bores defined in a longitude pattern on outer cylindrical surface that each balancing pin bore partially overlapping with the keyway, and a plurality of combination pin bores defined also in a longitude pattern on outer cylindrical surface and angularly spaced apart from the balancing pin bores that each combination pin bore communicating with one of the balancing pin bores. The combination pin bores are arranged such that each one of the combination pin bore extends coaxially with a corresponding one of the driver pin bores when the plug is in a first rotational orientation relative to the housing. A plurality of combination pins are slidably disposed into the combination pin bores, and a plurality of spring balancing pins and coiled compression balancing springs being slidably disposed into the balancing pin bores. The balancing pin bores are sealed by balancing pin bore seals.

The main difference between the cylinder lock of the present invention with the cylinder lock in prior art is the initial-on-duty pin. Almost all the cylinder lock in the prior art use its driver pins as its initial-on-duty pins which span the plug from rotating within the lock housing while the combination pins or pin sub-assemblies are normally exposed to the opening keyway. This pin-configuration makes lock picking or bumping practically or theoretically easy. The cylinder lock of the present invention uses the combination pins as the initial-on-duty pins and isolates these pins from the opening keyway. Each combination pin's position is not controlled directly by the key profile and the driver spring as it is in the prior art, but by the compound force of its corresponding balancing spring and driver spring. The extension force of the balancing spring at its initial pre-loaded length within the balancing pin bore is greater than the extension force of its corresponding driver spring at its initial fully loaded length within the driver pin bore. The key profile can only touch the balancing pins and move them to such new positions that the top end of all combination pins being just tangent to the outer cylindrical surface of the plug, or as we say the share line of the locking mechanism. By those new approaches, the cylinder lock of the present invention makes it impossible to unlock the lock by means of conventional lock picking or bumping technologies.

The above mentioned new locking mechanism may be achieved also by a minor modification which replaces the balancing pin, balancing spring and balancing bore seal with a magnetic balancing pin and a magnetic seal pin. In this embodiment, the extension force of the balancing spring is substituted by the repulsive force of the magnetic pin pair. The repulsive force of the magnetic pin pair at their biggest separation is greater than the extension force of the driver spring at its fully loaded length. The magnetic poles of the magnetic balancing pin and magnetic seal pin are arranged in such way that the like poles of the magnetic balancing pin and the magnetic seal pin are facing each other so they are repelled each other within the balancing pin bores on the plug all the time. In this embodiment, all components except the magnetic balancing pins and magnetic seal pins are made of non-magnetic material, such as brass.

Overall, the foregoing objects and other advantages of the present invention will become more apparent from the following detailed description when taking in conjunction with the reference drawings.

### BRIEF DESCRIPTION OF THE DRAWINGS

The structure, features and functions of this invention are described in detail with reference to the following description together with the accompany drawings, in which:

FIG. 1 is a front view, partially sectioned, of first embodiment of an exemplary cylinder lock of the present invention in case of no key engaged.

FIG. 2 is a sectional view of the lock of FIG. 1, taken along the line I-I in FIG. 1.

FIG. 3 is an exploded perspective view of the cylinder lock in FIG. 1 showing all necessary components of the present invention.

FIG. 4 is an isolated perspective view of the housing, partially sectioned, used in the present invention.

FIG. 5 is an isolated perspective view of the plug, partially sectioned, used in the cylinder lock of the present invention.

FIG. 6 is a sectional view of the cylinder lock in FIG. 1 showing its unlocking mechanism.

FIG. 7 is a sectional view of the cylinder lock in FIG. 1 showing the picking-resistant features of the present invention.

FIG. 8 is a longitudinally sectional view of second embodiment of an exemplary cylinder lock of the present invention in case of no key engaged.

FIG. 9 is an exploded perspective view of the cylinder lock in FIG. 8 showing all necessary components of the present invention.

FIG. 10 is a sectional view of the cylinder lock in FIG. 8 showing its unlocking mechanism.

FIG. 11 is a perspective view of the key used in the cylinder lock of the present invention.

FIG. 12 is a front view of an exemplary cylinder lock of the present invention in case of no key engaged.

### DETAILED DESCRIPTION OF THE INVENTION

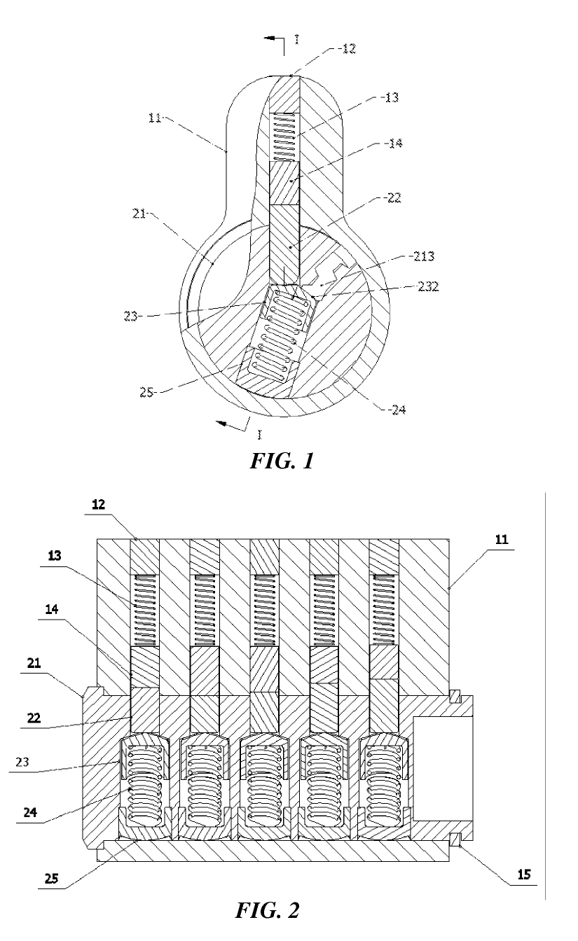

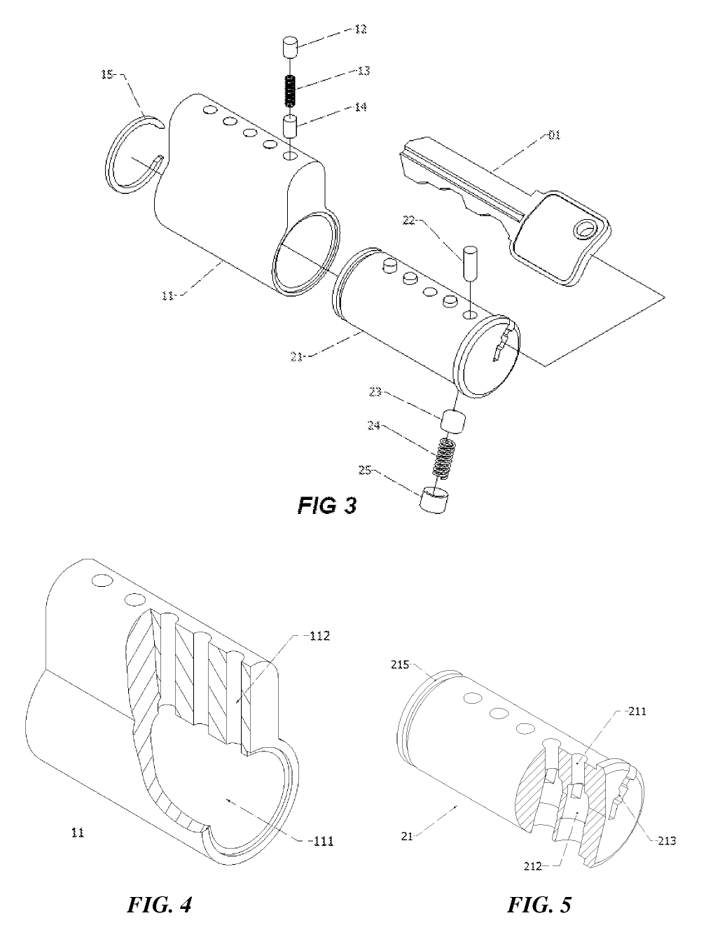

With reference to FIG. 1, FIG. 2 and FIG. 3, a first preferred embodiment of an exemplary high security cylinder lock in accordance with the present invention comprises a housing 11, a plurality of driver pins 14, coiled compression driver springs 13 and driver pin bore seals 12; a plug 21 rotatable within the housing 11 by means of a key (not shown) as known in the art, a plurality of combination pins 22; a plurality of spring balancing pins 23, coiled compression balancing springs 24, and balancing pin bore seals 25.

With reference to FIG. 2 and FIG. 4, the housing 11 comprises a through bore 111 and a plurality of driver pin bores 112 which are communicating with the through bore 111 and outer peripheral surface.

Slidably disposed into each driver pin bore 112 are a driver pin 14 and a coiled compression driver spring 13. The driver pin bores 112 are fixedly sealed with driver pin bore seals 12. The driver pin bores 112 may also be sealed by a seal strip (not shown) as commonly used in the art.

Referring to FIG. 2 and FIG. 5, the plug 21 comprises a keyway 213; a plurality of balancing pin bores 212 defined in a longitude pattern on outer cylindrical surface and partially overlapping with the keyway 213 of the plug 21; same number of combination pin bores 211 defined also in a longitude pattern on outer cylindrical surface and angularly apart from the balancing pin bores 212 for approximate 165 degree, each communicating with one of the corresponding combination pin bores 212. The combination pin bores 211 are arranged such that each one of the combination pin bore 211 extends coaxially with a corresponding one of the driver pin bores 112 when the plug 21 is in a first rotational orientation relative to the housing 11.

The plug 21 is rotatably mounted within the housing 11, preferably by means of a retaining ring 15 which is disposed into an annular groove 215 on the plug 21 so to prevent the plug 21 from moving axially in the through bore 111.

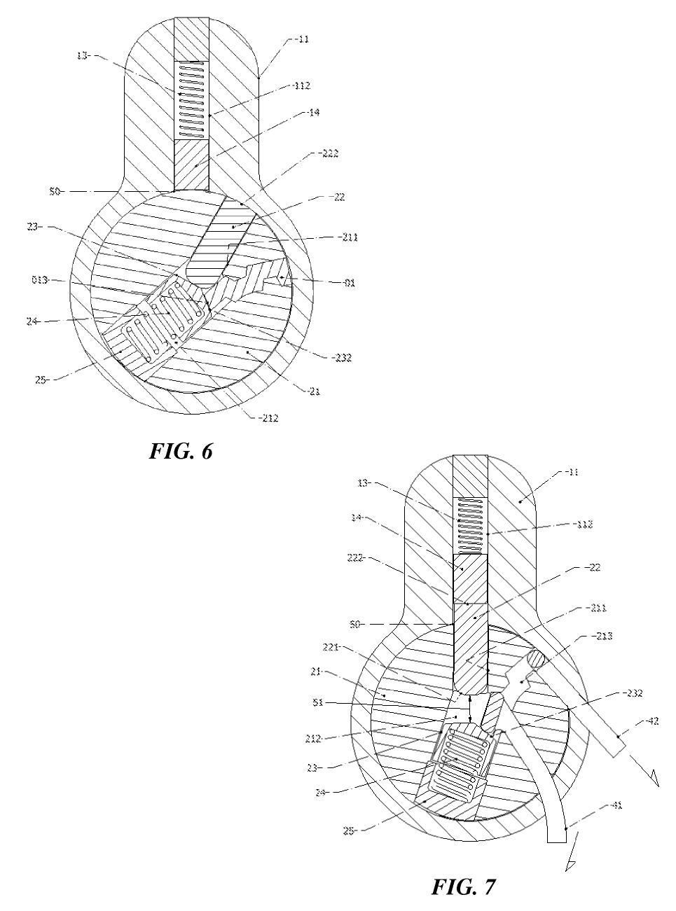

In the first embodiment of the present invention, each spring balancing pin 23 together with a coiled compression balancing spring 24 are slidably disposed into a balancing pin bore 212. The balancing pin bore 212 is then fixedly sealed by a balancing pin bore seal 25. A key-receiving top portion 232 of each spring balancing pin 23 is exposed to the keyway 213 for receiving key profile 013 when a key 01 is engaged (See FIGS. 6 & 12).

Disposed into the combination pin bores 212 are the combination pins 22. The length of each combination pins 22 varies. The shortest length of the combination pin 22 is such long that its top end 222 being tangent to the outer cylindrical surface of the plug 21 when its contacting spring balancing pin 23 is at its most extended position. The longest length of the combination pin 22 is such long that its top end 222 being tangent to the outer cylindrical surface of the plug 21 when its contacting spring balancing pin 23 is at its most retracted position.

Referring to FIG. 1 and FIG. 2 again, when the plug 21 is in place and at a first rotational orientation relative to the housing 11, each combination pin bore 211 extends coaxially with a corresponding one of the driver pin bores in the housing 11 so to allow each driver pin 14 to be extendable into its corresponding combination pin bore 211 on the plug 21, and allow each combination pin 22 to be extendable into a corresponding driver pin bore 112 on the housing 11.

FIG. 1 illustrates the locking mechanism of the first preferred embodiment of the present invention. As shown on the FIG. 1, the combination pin 22 is sandwiched between the driver pin 14 and the spring balancing pin 23. The position of the combination pin 22 is determined by the compound force of the balancing spring 24 and the driver spring 13. The extension force of the balancing spring 24 at its initial pre-loaded length within the balancing pin bore 212 is greater than the extension force of driver spring 13 at its initial fully-loaded length in the driver pin bore 112, so the spring balancing pin 23 is forced by the compound force to its most extended position in case of no key engaged, while the driver pin 14 is at its most retracted position for the same reason. There must be at least one combination pin 22 being extended into the driver pin bore 112 on the housing 11 when the plug 21 is at first rotational orientation relative to the housing 11. The extended combination pin(s) 22 will span the plug 21 and the housing 11 so the plug 21 is unable to rotate within the housing 11.

FIG. 6 illustrates the unlocking mechanism of the first preferred embodiment of the present invention. When a key 01 with correct profile 013 is inserted into the keyway 213, the profile 013 contacts the key-receiving top portion 232 of each spring balancing pin 23, overcomes the extension force of each balancing spring 24 and moves each spring balancing pin 23 within the balancing pin bore 212 to such a position that it allows the top end 222 of its contacting combination pin 22 just to be tangent to the outer cylindrical surface 50 of the plug 21 under the extension force of the driver spring 13. The plug 21 is then free to rotate within the housing 11.

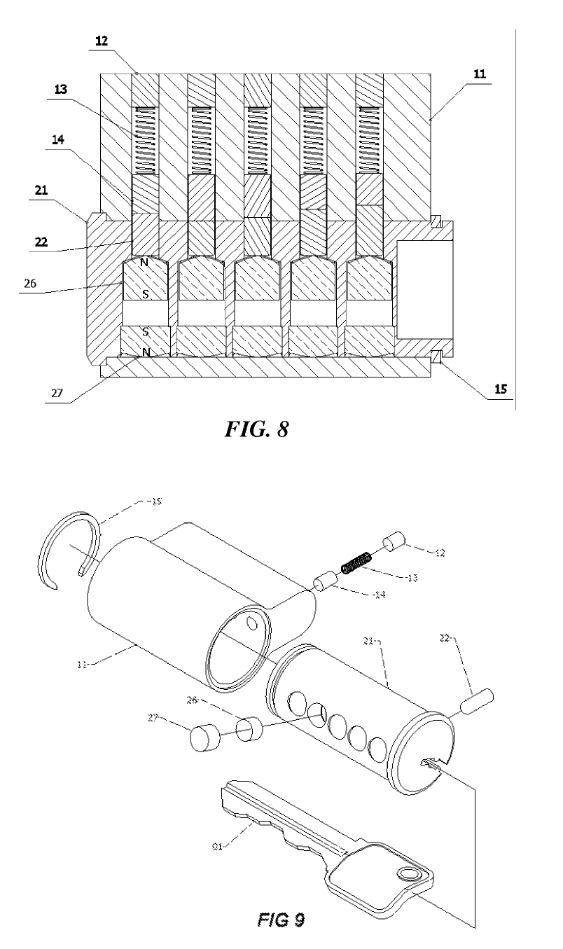

FIG. 7 illustrates the anti-picking mechanism of the present invention. In the prior art, the driver pins are initial-on-duty to span the plug from rotating within the housing while the combination pins are exposed to the opening keyway. To pick a conventional cylinder lock, one needs to apply a small rotation torque to the plug first and to employ a picking tool to tentatively depress a selective combination pin through the keyway so to find a skewed driver pin. One further depresses the skewed pin toward the driver pin bore until getting a feeling that the other end of the driver pin goes cross the shear line. This picking method does not work on the cylinder lock of the present invention. As shown in FIG. 8, when a picking tool 42 applies a rotation torque onto the plug 21, at least one combination pin 22 will be skewed by the possible misaligned bores 112 & 211 due to the manufacturing tolerance. Since the combination pin 22 is not exposed directly to the keyway 213, it is hard to know which combination pin 22 being skewed. The picking tool 41 can touch the key-receiving top 232 of the spring balancing pin 23 and move the spring balancing pin 23 up and down within the balancing pin bore 211, but it only produces a gap 51 between the combination pin 22 and the spring balancing pin 23. The extension force of the driver spring 13 is so tiny to overcome the friction caused by the pin skewing, the picking attempt must fail.

FIG. 8 to FIG. 10 illustrate a second preferred embodiment of an exemplary high security cylinder lock in accordance with the present invention. In second preferred embodiment, the lock comprises a housing 11, a plurality of driver pins 14, coiled compression driver springs 13 and driver pin bore seals 12; a plug 21 rotatable within the housing 11 by means of a key (not shown) as known in the art, a plurality of combination pins 22; a plurality of magnetic balancing pins 26 and magnetic seal pins 27 instead of spring balancing pins 23, balancing springs 24, and plug seals 25 used in the first preferred embodiment of the cylinder lock of present invention.

In the second preferred embodiment of the present invention, all components, except magnetic balancing pins 26 and magnetic seal pins 27, may be identical to those used in the first preferred embodiment in terms of shapes and functions. However, all components, except the magnetic balancing pin 26 and magnetic seal pin 27, are made of non-magnetic material, such as brass.

FIG. 8 illustrates the locking mechanism of the second preferred embodiment of the present invention. In this embodiment, the combination pin 22 is sandwiched between the driver pin 14 and the magnetic balancing pin 26. The position of the combination pin 22 is determined by the compound force of the magnetic repulsive force of the magnetic balancing pin 26 and the extension force of the driver spring 13. The magnetic repulsive force is generated between the magnetic balancing pin 26 and magnetic seal pin 27. The magnetic poles of the magnetic balancing pin 26 and magnetic seal pin 27 are arranged in such way that the like poles of each pair of magnetic balancing pin 26 and magnetic seal pin 27 are facing each other so they are repelled each other within their residing balancing pin bore 212 on the plug 21 all the time. FIG. 8 shows the south pole S of a magnetic balancing pin 26 faces to the south pole S of the magnetic seal pin 27 within their residing balancing pin bore 212. The repulsive force between the magnetic balancing pin 26 and magnetic seal pin 27 at their biggest separation within their resided balancing pin bore 212 is greater than the extension force of driver spring 13 at its fully-loaded length in the pin bore 112 on the housing 11, so the magnetic balancing pin 23 is forced by the compound force to its most extended position in case of no key force engaged, while the driver pin 14 is at its most retracted position for the same reason. There must be at least one combination pin 22 being extended into the driver pin bore 112 on the housing 11 when the plug 21 is at first rotational orientation relative to the housing 11. The extended combination pin(s) 22 will span the plug 21 and the housing 11 so the plug 21 is thus blocked from rotating within the housing 11.

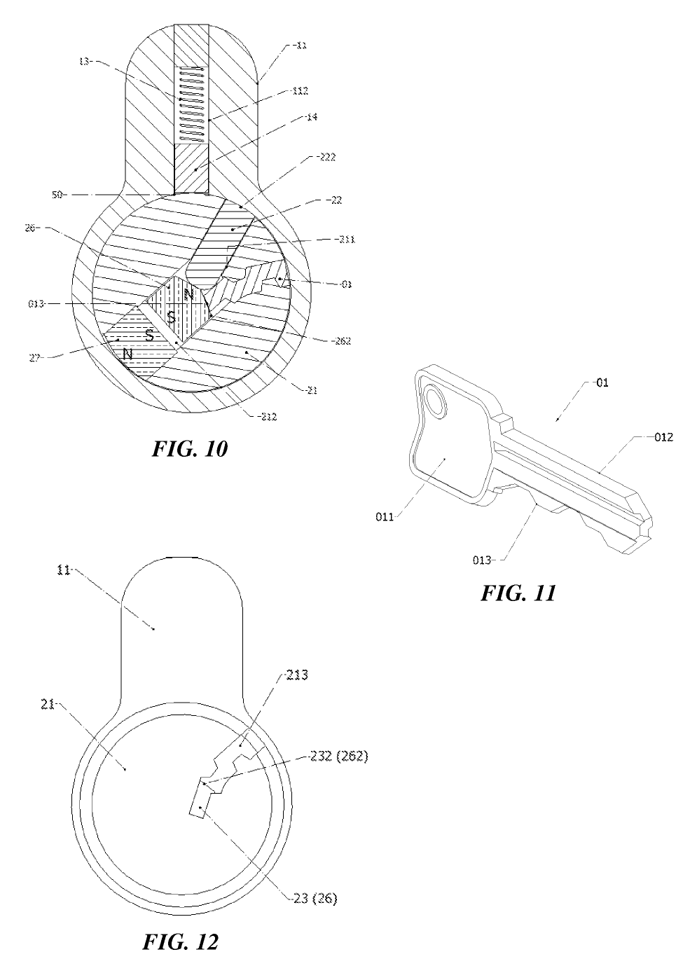

FIG. 10 illustrates the unlocking mechanism of the second preferred embodiment of the present invention when a key 01 with correct profile 013 engaged. When the correct key 01 inserted into the keyway 213, the profile 013 of the key 01 contacts the key-receiving top portion 262 of each magnetic balancing pin 26, overcomes the repulsive force between the magnetic balancing pin 26 and magnetic seal pin 27 and position the magnetic balancing pin 26 within the balancing pin bore 212 to such a position that it just allow the top end 222 of its contacting combination pin 22 being tangent to the outer cylindrical surface 50 of the plug 21 under the extension force of the driver spring 13. The plug 21 is then free to rotate within the housing 11.

Referring to FIG. 11, an exemplary key 01 used in present invention comprises a key body 012, a key handle 011 and a key profile 013.

FIG. 12 shows the front view of the cylinder lock described above. Exposed to the keyway 213 are either the key-receiving tops 232 of spring balancing pins 23 in accordance with the first preferred embodiment of the present invention or the key-receiving tops 262 of magnetic balancing pins 26 in accordance with the second preferred embodiment of the present invention.

Various modifications of the disclosed embodiments will be apparent to those skilled in the art. Other shaped balancing pin and balancing bore seal could be used. Different patterns of cross section or position of the keyway is within the scope of the invention. Regarding the configuration of the balancing pin, it may be all spring balancing pin type, all magnetic balancing pin type, or a combination.

What is claimed is:

1. A cylinder lock comprising:
a housing having a through bore and a plurality of driver pin bores communicating with said through bore and outer peripheral surface;
a plurality of driver pins and driver springs being slidably disposed into said driver pin bores in said housing;
whereas said driver pin bores being sealed by driver pin bore seals;
a plug having a keyway, a plurality of balancing pin bores defined in a longitude pattern on outer cylindrical surface, and a plurality of combination pin bores defined in a longitude pattern on outer cylindrical surface and angularly apart from said balancing pin bores;
whereas said plug being rotatably mounted within said housing;
whereas each said balancing pin bore being partially overlapping with said keyway;
whereas each said combination pin bores being communicating with one of said balancing pin bores;
whereas said combination pin bores being arranged such that each one of said combination pin bores extends coaxially with a corresponding one of said driver pin bores when said plug is in a first rotational orientation relative to said housing;
a plurality of spring balancing pins and coiled compression balancing springs being slidably disposed into said balancing pin bores respectively;
wherein said balancing pin bores being sealed by balancing pin bore seals;
a plurality of combination pins being slidably disposed into said combination pin bores;

2. A cylinder lock according to claim 1 and wherein the extension force of each said balancing spring at its initial pre-loaded length within said balancing pin bore is greater than the extension force of its corresponding said driver spring at its initial fully loaded length within said driver pin bore.

3. A cylinder lock according to claim 1 and wherein said combination pins' length varies that the shortest length is such long that its top end being tangent to the outer cylindrical surface of said plug when its contacting spring balancing pin is at its most extended position and the longest length is such long that its top end being tangent to the outer cylindrical surface of said plug when its contacting spring balancing pin is at its most retracted position.

4. A cylinder lock according to claim 1 wherein said cylinder lock further has means for retaining said plug in said housing so to prevent said plug from moving axially;

5. A cylinder lock comprising:
a housing having a through bore and a plurality of driver pin bores communicating with said through bore and outer peripheral surface;
a plurality of driver pins and driver springs being slidably disposed into said driver pin bores in said housing;
whereas said driver pin bores being sealed by driver pin bore seals;
a plug having a keyway, a plurality of balancing pin bores defined in a longitude pattern on outer cylindrical surface, and a plurality of combination pin bores defined in a longitude pattern on outer cylindrical surface and angularly apart from said balancing pin bores;
whereas said plug being rotatably mounted within said housing;
whereas each said balancing pin bore being partially overlapping with said keyway;
whereas each said combination pin bores being communicating with one of said balancing pin bore;
whereas said combination pin bores being arranged such that each one of said combination pin bores extends coaxially with a corresponding one of said driver pin bores when said plug is in a first rotational orientation relative to said housing;
a plurality of magnetic balancing pins being slidably disposed into said balancing pin bores respectively;
whereas each said balancing pin bores being fixedly sealed by a magnetic pin seal;
a plurality of combination pins being slidably disposed into said combination pin bores.

6. A cylinder lock according to claim 5 and wherein the magnetic poles of said magnetic balancing pin and magnetic seal pin are arranged in such way that the like poles of each pair of magnetic balancing pin and magnetic seal pin are facing each other so they are repelled each other within their residing balancing pin bore on said plug.

7. A cylinder lock according to claim 5 and wherein the repulsive force between said magnetic balancing pin and said magnetic seal pin at their biggest separation within their residing balancing pin bore on said plug is greater than the extension force of said driver spring at its fully-loaded length in its residing pin bore on said housing.

8. A cylinder lock according to claim 5 and wherein all components except said magnetic balancing pins and said magnetic seal pins are made of non-magnetic material, such as brass.

9. A cylinder lock according to claim 5 wherein said cylinder lock further has means for retaining said plug in said housing so to prevent said plug from moving axially;
